(19) United States
(12) Patent Application Publication
(10) Pub. No.: US 2005/0082008 A1
(43) Pub. Date: Apr. 21, 2005

(54) Method and apparatus for automatic re-starting of web edge trimming after moving web leaves point of trimming

(76) Inventor: William Oliver Young, Spartanburg, SC (US)

Correspondence Address: William O. Young, 2730 Cannons Campground Rd, Spartanburg, SC, 29307, US

(21) Appl. No.: 10/967,370

(22) Filed: Oct. 16, 2004

Related U.S. Application Data
(60) Provisional application No. 60/511,909, filed on Oct. 16, 2003.

(51) Int. Cl. B32B 31/00

(52) U.S. Cl. 156/515; 156/496

(57) ABSTRACT

An apparatus which permits efficient, operator-free ultrasonic cutting/sealing of web edge at exit of a tenter frame

### CROSS-REFERENCE TO RELATED APPLICATIONS

This application claims the benefit of provisional patent application No. 60/511,909 filed Oct. 16, 2003, by the present inventor, the contents of which are incorporated by reference herein in their entirety.

### FIELD OF INVENTION

This invention relates to webs of textile fabric, and others, specifically to a method of improving efficiency of ultrasonic cutting/sealing of edges of such webs at exit of a tenter frame.

### BACKGROUND OF THE INVENTION/PRIOR ART

It is often necessary to trim edges of finished textile fabric, or other such webs, in order to produce the quality edge required for subsequent converting operations.

Web of knitted construction, or nonwoven web whose fibers are bonded to each other, may be edge-trimmed effectively by shearing, by high speed rotary blade, by stationary knife, or by other methods without loose threads protruding from body of trimmed web.

However, if web whose edges are to be trimmed is of woven construction, cutting as above will not produce a quality edge. Instead, warp threads which have been cut will tend to separate and protrude from body of web; if of sufficient length or quantity, resultant loose threads may become tangled in and/or damage process machinery. Additionally, stoppage required to correct such a problem may damage web being processed.

If woven web has high thermoplastic fiber content, e.g., polyester or nylon, high quality edge will be obtained with ultrasonic cutting/sealing, or other methods which melt fiber in act of trimming, because edge is simultaneously cut and heat-sealed. Because residue from ultrasonically-melted fibers does not tend to accumulate on trimming elements, thereby eliminating need for stopping process for periodic cleaning, the ultrasonic method of trimming is often preferred over other available methods. The ultrasonic cutting/sealing process normally includes a horn, vibrating at very high frequency, in contact with a stationary anvil shaped to produce cut/sealed edge on web passing between said two elements.

It is desirable to trim web edge at exit of tenter frame because tentering, drying, and heat setting are often the last steps in the textile manufacturing process, the web is under precise lateral control as it leaves tenter frame, and quality of finished product is high.

However, in the event web edge is not captured, or is mis-pinned, at tenter frame entry because of a seam which is too thick, whose edges are mis-matched, or the like, body of web may by-pass point of trimming, resulting in untrimmed edge and off-quality product.

Ultrasonic cutting/sealing at tenter frame exit is often not practical because, in the event of such a mis-pin, anvil must be separated from horn, web edge must be returned to trimming area, and anvil must be placed back into contact with horn, all of which steps are normally manually performed by an operator and require rails of tenter frame to be stopped. Since drying process continues to function, however, if tenter frame must be stopped in order to re-start trimming, stationary web in heated section of tenter frame is in danger of being burned, resulting in ruined and unusable product.

### SUMMARY OF THE INVENTION

The present invention offers advantages over and an alternative to the known art by providing a way to ultrasonically cut/seal edges of web at it exits tenter frame, for example, without interruption to web flow and without operator attention in the event web should leave point of trimming.

### BRIEF DESCRIPTION OF DRAWINGS

FIG. 1 illustrates present invention as it would be seen from side with web flow to right of observer.

FIG. 2 illustrates schematic view of elements of present invention as seen from above.

FIG. 3 illustrates properly-functioning ultrasonic cutting/sealing process.

FIG. 4 illustrates edge of web leaving point of cutting/sealing path because of mis-pin.

FIG. 5 illustrates beginning phase of present invention.

FIG. 6 illustrates ending phase of present invention.

### DETAILED DESCRIPTION OF DRAWINGS

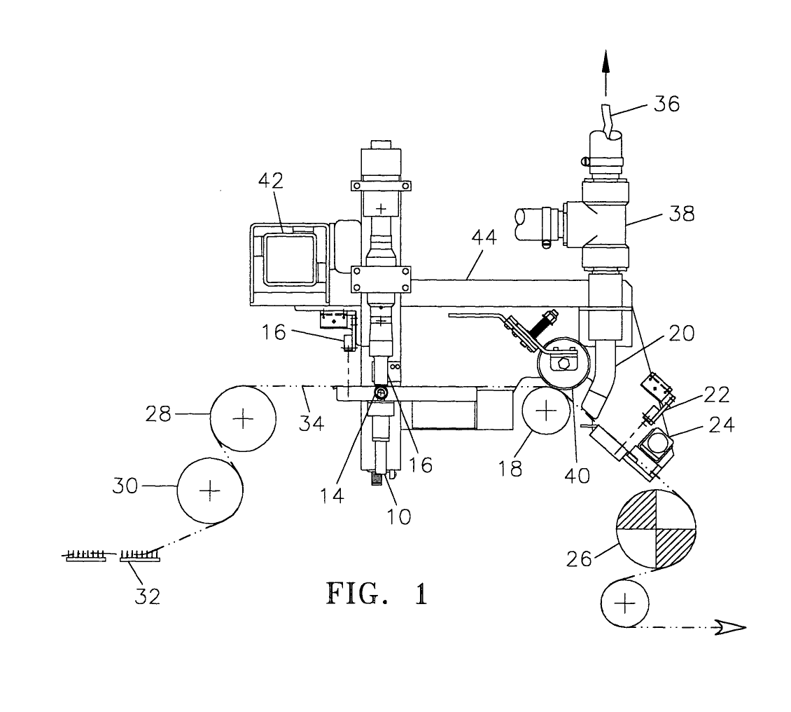

In FIG. 1, in a preferred arrangement, the apparatus includes:
Tenter pins 32 from which untrimmed web 34 has been stripped and pulled around roll 30 and 28, and under sensor 16 and onto ultrasonic horn 16 and anvil 14.
Steel beam 42 which supports mounting framework 44
Nip roller 40 which is spring-loaded against idler roll 18 so as to maintain tension on trimmed web edge 36
Nozzle 20 into which edge 36 is drawn by vacuum produced by aspirator 38
Sensor 16 for detecting presence of untrimmed edge
Sensor 22 for detecting undesired presence of trimmed edge 36
Clipper 24 for separating trimmed edge 36 from body of web
Air cylinder 10 which is used to raise anvil 14 into contact with horn 16 for cutting/sealing or to lower anvil 14 and provide clearance between anvil 14 and horn 16 for introduction of untrimmed web edge
Control system 46, PLC or the like, which uses signals from sensor 16 and sensor 22 to control anvil 14 and dipper 24

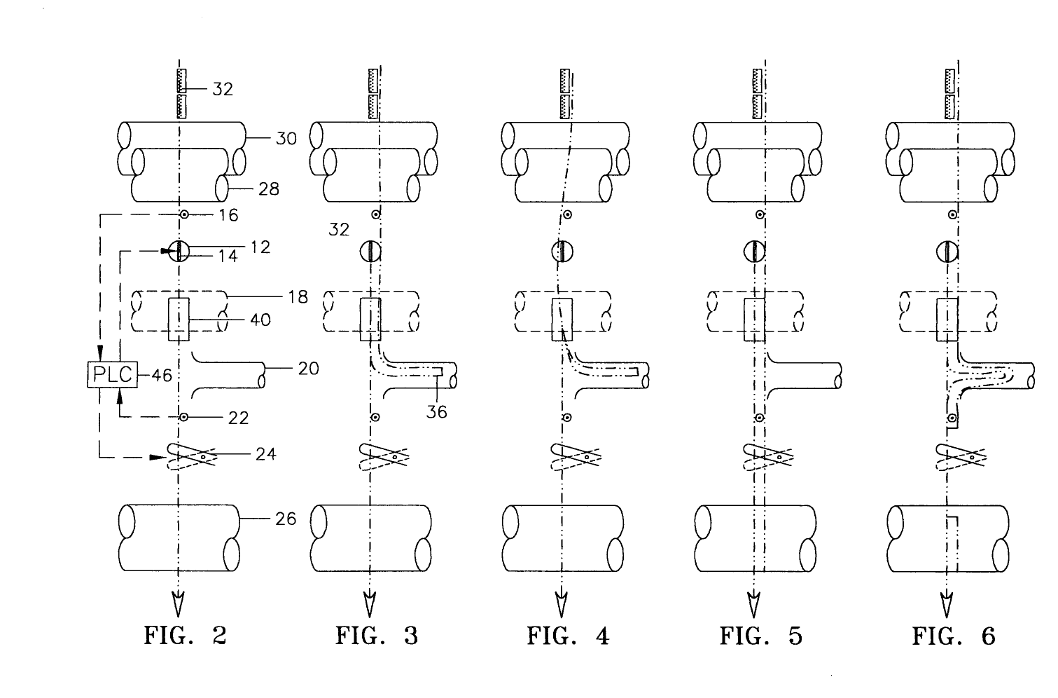

FIG. 2 illustrates schematic view of apparatus in FIG. 1 as seen from above.

FIG. 3 illustrates cutting/sealing process in correct operation:
Anvil 14 and horn 12 are in contact with each other, cutting and sealing web 34 as it passes between the two elements
Sensor 16 confirms that edge is in correct position to be trimmed
Trimmed edge 36 is being withdrawn via nozzle 20
Sensor 22, detecting no presence of web, confirms that trimmed edge 36 is being withdrawn via nozzle 20 and is not attached to body of web 32
Clipper 24 is open and inactive

FIG. 4 illustrates that a mis-pin has taken web 32 outside point of cutting/sealing, calling for automatic re-start controlled by control system 46

Sensor 16 confirms that web 32 passed outside cutting/sealing point and calls for anvil 14 to be lowered so that fabric may re-enter said point.

FIG. 5, illustrates that web 32 has re-entered cutting/sealing point. Upon confirmation by sensor 16, anvil 14 is raised and cutting/sealing process resumes.

FIG. 6 illustrates that, following a short time delay after raising of anvil 14, clipper 24 is called on to cut trimmed edge 36, thereby detaching it from body of web 32. After being clipped, end of trimmed edge 36 is withdrawn back into nozzle 20 by vacuum produced by aspirator 38, and normal operation as in FIG. 3 is resumed. Sensor 22 confirms that trimmed edge 36 is successfully detached from web 32.

Should detachment described above not be successful, as detected by sensor 22, sequence of present invention would be repeated.

In a Preferred Embodiment:
Sensor 16 and sensor 22 is photoelectric—either light-emitting diode or laser.
Clipper 24 has soft polyurethane cover and is 2 inches (50 mm) wide.
Power for horn 16 is at least 1 KW.

1. An apparatus which will permit efficient, operator-free ultrasonic cutting/sealing of suitable web at exit of a tenter frame, which apparatus comprising sequentially in direction of web flow, entry idler rolls for taking web from tenter frame to an ultrasonic cutting/sealing unit, nip roller for maintaining tension on trimmed edge, vacuum suction for removal of trimmed edge, electronic or pneumatic clippers for detaching trimmed edge from body of web, actuator for raising and lowering anvil below ultrasonic horn, sensors for monitoring trimming performance and detecting operation of said anvil and clippers to yield a completely automatic method of restarting process after failure to cut/seal.
